(19) United States
(12) Patent Application Publication
(10) Pub. No.: US 2003/0041015 A1
(43) Pub. Date: Feb. 27, 2003

(54) Wireless method for bidding for the products of a provider of such products

(75) Inventor: Srinivas Gutta, Buchanan, NY (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 09/935,886

(22) Filed: Aug. 23, 2001

(51) Int. Cl. G06F 17/60

(52) U.S. Cl. 705/37

(57) ABSTRACT

A method for bidding for the products of a provider. The method including the step of: contacting one or more providers of a product within a predetermined area through a first wireless transmission from a user; initiating a bid for the product with the one or more providers through a second wireless transmission; bidding on the product by the one or more providers; and accepting a lowest bid on the product from one of the one or more providers through a third wireless transmission.

### BACKGROUND OF THE INVENTION

1. Field of the Invention

The present invention relates generally to bidding for the goods/services (hereinafter collectively referred to as products) of a provider of such products, and more particularly, to a wireless method of bidding for products of a provider of such products.

2. Prior Art

There are systems known in the art wherein a user bids for an airline seat, or a grocery item by naming a price and the system either accepts or rejects the bid price (known in the art as a reverse auction). However, no bidding methods are known which are carried out wirelessly in which product providers within a certain predetermined area bid for the business of a user who has or will enter the predetermined area and who has a need, often an immediate need, for the products. For instance, a user who is traveling in an automobile or other vehicle (e.g., truck, boat, etc.) into a predetermined area needs a certain product when entering the predetermined area (e.g., gasoline, fix a flat tire, lunch, etc.). The user of the vehicle has no recourse but to manually find a provider of the desired product in the area and pay for the product, or manually find several providers of the desired product and compare prices before paying for the product.

### SUMMARY OF THE INVENTION

Therefore it is an object of the present invention to provide a method of bidding for products of a provider of such products which can be carried out in a wireless medium.

It is another object of the present invention to provide a method of bidding for products of a provider of such products which are located within a predetermined area.

It is still a further object of the present invention to provide a method of bidding for products of a provider of such products by a user who has or will enter the predetermined area and who has a need for the products.

It is yet still a further object of the present invention to provide a method of bidding for products of a provider of such products by a user which eliminates manual searching for the product in a predetermined area.

Accordingly, a method for bidding for the products of a provider of said products is provided. The method comprising: contacting one or more providers of a product within a predetermined area through a first wireless transmission from a user; initiating a bid for the product with the one or more providers through a second wireless transmission; bidding on the product by the one or more providers; and accepting a lowest bid on the product from one of the one or more providers through a third wireless transmission.

Preferably, the contacting step comprises transmitting the first wireless transmission with a code corresponding to the product, wherein any provider of such product that detects the first wireless transmission can participate in the bidding step.

The initiating step preferably comprises providing a starting bid in the second wireless transmission by the user, where the first and second wireless transmissions preferably comprise a single message transmission.

The initiating step preferably comprises providing a starting bid in the second wireless transmission by at least one of the one or more providers.

Where the one or more providers comprises at least two providers, the bidding step can comprise: receiving bids from each of the at least two providers to the user through a fourth wireless transmission; transmitting the lowest of the received bids from the user to the other of the at least two providers through a fifth wireless transmission; and repeating the receiving and transmitting steps until the lowest bid is accepted. Alternatively, the bidding step can comprise: transmitting bids between each of the at least two providers; transmitting the lowest of the received bids from one of the at least two providers to the other of the at least two providers in a fourth wireless transmission; repeating the transmitting steps until the lowest bid is accepted; and transmitting the lowest bid to the user in a fifth wireless transmission, wherein the step of transmitting bids between each of the at least two providers is preferably through a wireless transmission.

The accepting step can comprise: manually indicating acceptance of the lowest bid by the user; and transmitting the indication of acceptance through the third wireless transmission to at least the provider making the lowest bid. Alternatively, the accepting step can comprise: automatically indicating acceptance of the lowest bid by the user upon fulfillment of a predetermined criteria; and transmitting the indication of acceptance through the third wireless transmission to at least the provider making the lowest bid.

Furthermore, the method can further comprise transmitting additional information to the user from at least one of the one or more providers to the user during the bidding step, wherein the step of transmitting additional information preferably comprises transmitting image data corresponding to the product and further comprising the step of displaying the image data to the user. The step of transmitting additional information to the user from at least one of the one or more providers can also be performed after the accepting step, wherein the step of transmitting additional information preferably comprises transmitting a confirmation from the provider with the lowest bid to the user confirming that the lowest bid will be recognized by the provider making the lowest bid.

Also provided is a wireless communication device comprising: means for contacting one or more providers of a product within a predetermined area through a first wireless transmission; and means for accepting a lowest bid on the product from one of the one or more providers through a second wireless transmission.

Still yet provided are a computer program product for carrying out the methods of the present invention and a program storage device for the storage of the computer program product therein.

### BRIEF DESCRIPTION OF THE DRAWINGS

These and other features, aspects, and advantages of the apparatus and methods of the present invention will become better understood with regard to the following description, appended claims, and accompanying drawings where:

FIG. 1 illustrates a flowchart showing the preferred steps of the methods of the present invention.

FIG. 2 illustrates a schematic representation of a system for carrying out a preferred implementation of the methods of FIG. 1.

FIG. 3 illustrates a dashboard configuration of an automobile of FIG. 2.

FIG. 4A illustrates a personal digital assistant configured for carrying out the methods of the present invention.

FIG. 4A illustrates a cellular telephone configured for carrying out the methods of the present invention.

FIG. 5 illustrates a schematic diagram of the preferred configuration of the wireless communication devices of FIGS. 3, 4A, and 4B.

### DETAILED DESCRIPTION OF THE PREFERRED EMBODIMENT

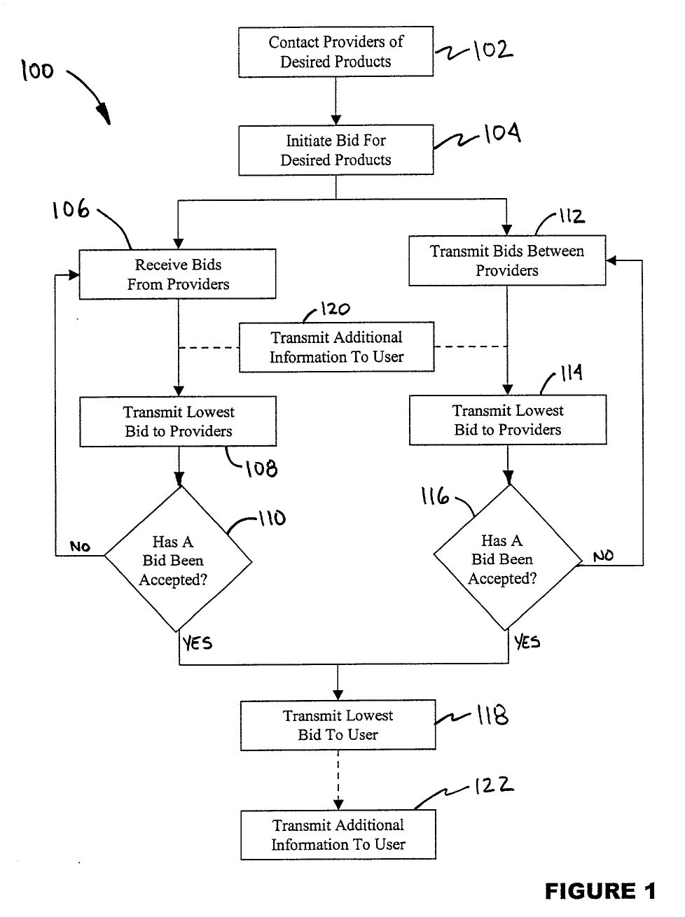

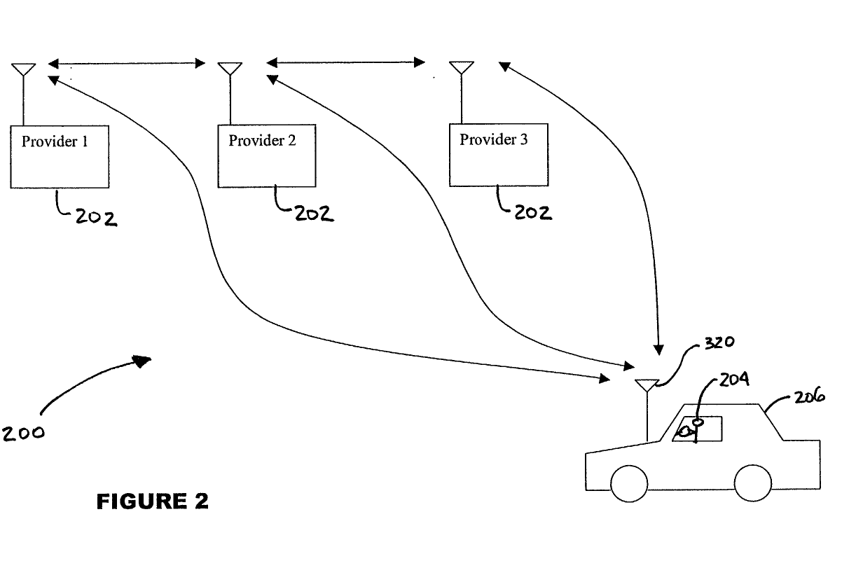

Referring now to FIGS. 1 and 2, there is illustrated a flowchart and system, respectively, of a preferred implementation for bidding for the products of a provider of said products. As discussed above, the use of the term “products” is used to mean both goods and services. Furthermore, the term “provider” is used to mean any merchant, retailer, wholesaler or the like who sells or provides such goods or services. The method of FIG. 1 is generally referred to by reference numeral 100, while the system of FIG. 2 is generally referred to by reference numeral 200.

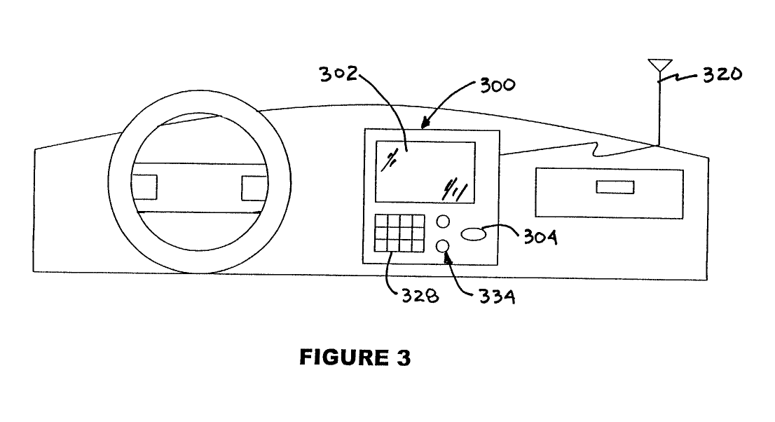

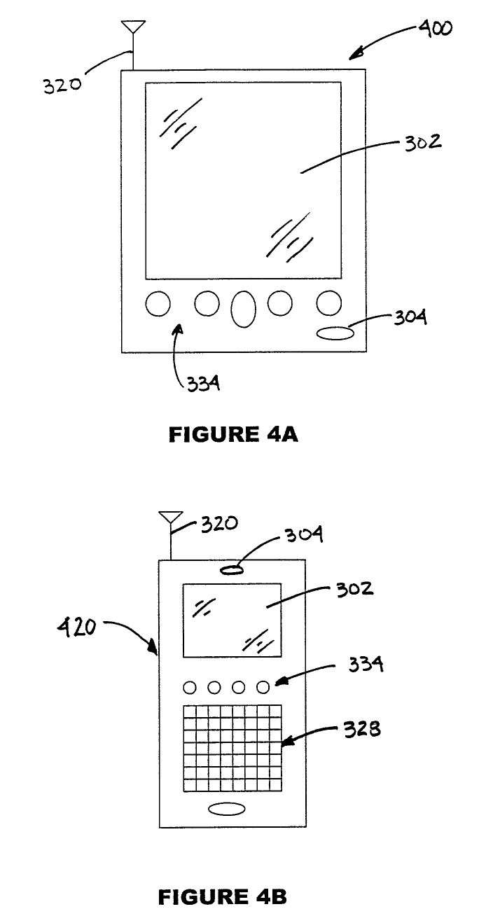

At step 102 of the method, one or more providers 202 of a product within a predetermined area are contacted through a wireless transmission from a user 204. Generally, a plurality of providers 202 will be contacted, although three are shown, a minimum of two providers 202 are necessary to carry out a bidding procedure. However, a single provider 202 can respond to the initial contact from the user 204. Furthermore, the user 204 is shown as an operator/passenger in an automobile 206 by way of example only and not to limit the scope or spirit of the present invention. The automobile is preferably outfitted with a wireless communication device 300 (FIG. 3). However, the wireless communication device 300 can be fixed in the automobile 206 or can be taken in and out of the automobile 206. The methods 100 of the present invention can be carried out from other modes of transportation, such as trucks, boats, etc. Furthermore, the methods 100 of the present invention do not have to be carried out from a vehicle, but can be carried out with any wireless communication device, such as a personal digital assistant (PDA) 400 (FIG. 4A) or a cellular telephone 420 (FIG. 4B).

At step 104, a bid for a particular product is initiated with the providers 202 through a wireless transmission. The contacting step 102 can comprise transmitting a wireless transmission with a code corresponding to the particular product the user 204 is interested in. Any provider 202 of such a product that detects the transmission, or alternatively the code in the transmission, can participate in the bidding step. Therefore, the strength of the transmission signal can be used to fix the size of the predetermined area. The initiating step 104 can include providing a starting bid in the wireless transmission by the user 204 along with the transmission of the code. Alternatively, a starting bid can be supplied upon the receipt of a transmission from the providers 202 that they are interested in participating in the bid. However, the user 204 does not have to initiate a bid, one or more of the providers 202 can transmit a starting bid to either the user 204 or to the other providers 202 in the predetermined area or to those who have expressed an interest in participating in the bid.

A bidding is then carried out where the providers 202 continue to bid on a price that they can provide to the user 204 for purchase of the desired product. The bidding continues until a bid is accepted. In a preferred implementation of the bidding, bids are received at step 106 from each of the providers 202 to the user 204 through a wireless transmission. The bids are received by the user 204 in response to the initial bid or the initial contact. At step 108, the lowest of the received bids is transmitted from the user 204 to the providers 202 or to the providers 202 other then the one making the lowest of the received bids. At step 110-No, the method 100 loops back to the receiving and transmitting steps 106, 108, which are repeated until the lowest bid is accepted at step 110-Yes.

Alternatively, the bidding can be carried out by transmitting bids at step 112 between each of the providers 202 participating in the bid. The transmission of bids between each of the providers is preferably through a wireless transmission but can also be a wired transmission, such as through a phone line, cable line, etc. The lowest of the received bids is then transmitted at step 114 from the provider 202 making the lowest bid to the other of the providers 202 in a wireless transmission. At step 116-No the method 100 loops back to the transmitting steps 112, 114, which are repeated until the lowest bid is accepted at step 110-Yes.

In either of the preferred bidding procedures, after a lowest bid is accepted, the lowest bid is transmitted to the user at step 118 in a wireless transmission. The acceptance of the lowest bid on the product from one of the providers is through a wireless transmission from the wireless communication device 300, 400, 420. Typically, the acceptance is made from the user 204 to only the provider 202 making the lowest bid, or alternatively, also to the remaining providers 202 to inform them of losing the bid.

The accepting step 110, 116 can be a manual indication of the acceptance of the lowest bid by the user 204. In such a situation, the user can press a button, touch an appropriate portion of a touch screen, issue a voice command or the like. The accepting step can also be done automatically upon fulfillment of predetermined criteria. For instance, the user 204 can predetermine that the first bid which is 10% lower then the initial bid will be accepted automatically.

Additional information can also be transmitted to the user 204 during the methods 100 of the present invention. Preferably, the additional information is transmitted during the bidding procedure at step 120 and/or after the acceptance at step 122. For instance, step 120 can comprise transmitting image data corresponding to the product and further comprising the step of displaying the image data to the user. For instance, a picture or video of the product can be transmitted and displayed to the user 204 during the bidding on the wireless communication device's display 302. Audio can also be supplied with or without the image data and reproduced on a speaker 304 integral with the wireless communication device 300, 400, 420.

The display 302 can display image data from more than one provider sequentially or it can be split between more then one provider 202, which transmits the image data. For example, if ten providers 202 are participating in the bid, and four transmit image data indicative of the their particular product (if the product is not generic), all four images can all be displayed simultaneously on a split display. The images can then be used by the user 204 in making a decision on which bid to accept or even by eliminating one or more of the providers 202 from the bid if their product is not desired by the user 204.

The additional information transmitted by the providers 202 after a low bid has been accepted can comprise a confirmation number from the provider 202 with the lowest bid to the user 204 a confirming that the lowest bid will be recognized by the provider 202 making the lowest bid. The additional information can also include directions for getting to the provider making the lowest bid; such directions can be textual, graphic, and/or audio. The providers 202 not winning the bid can also transmit information, such as a coupon or confirmation number to the user 204 for a next time the user desires the same product or for other related or non-related products that provider 202 may offer.

Alternatively, the user 204 may only desire additional information regarding a certain product or regarding the products a certain provider 202 carries. In such a situation, the user 204 can contact providers 202 in a similar manner as discussed above. However, instead of initiating a bid, the user only requests product information regarding the provider's products in general or product information on a specific product. Any providers 202 responding to the request or only a specific provider, which was targeted by the request, can then transmit the desired information. The transmitted information can then be displayed to the user 204 on the display 302 in a split screen or sequentially. Thus, a user 304 does not have to enter a provider's store to know the types of products they sell. For instance, if a driver of an automobile is approaching a rest area, the driver can request product information from the rest area and can use such information to decide whether or not to stop at the rest area.

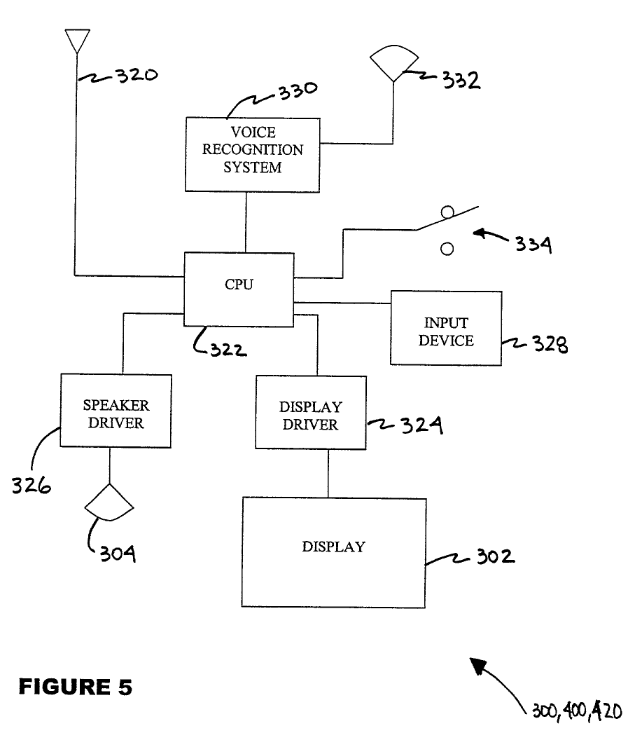

Referring now to FIG. 5, there is shown a schematic illustration of the preferred configuration of the wireless communication devices 300, 400, 420 of FIGS. 3, 4A, and 4B which are capable of carrying out the methods of the present invention. The wireless communication device 300, 400, 420 has an antenna 320 for transmitting and receiving transmissions between the providers 202. The antenna is preferably under the control of a central processor (CPU) 322. The CPU 322 and antenna 320 can be dedicated to carrying out the methods 100 of the present invention or also used in carrying out other functions of the wireless communication devices 300, 400, 420 (e.g., scheduling, making and receiving telephone transmissions). The wireless communication device 300, 400, 420 also preferably has a display 302 and speaker 304 as discussed above which are driven by a respective display driver 324 and speaker driver 326, both of which are also under the control of the CPU 322.

The wireless communication device 300, 400, 420 also has means for inputting data 328, such as a keyboard, keypad, touch screen, or the like. A voice recognition system 330 having a pick-up microphone 332 can also be used to input data into the wireless communication device 300, 400, 420. Data such as the desired product, desired product information, an initial bid for the desired product, or the predetermined criteria for accepting a bid can be input with the input means 328 or voice recognition system 330.

Press buttons 334 can also be provided on the wireless communication device 300, 400, 420. Such buttons 334 can be used to input data or to accept or decline a bid or to eliminate a provider 202 from bidding. For instance, buttons 334 can be pre-programmed to input an often used product, like gasoline, pressing a pre-programmed button 334 would then contact gasoline providers within a predetermined area (e.g., containing a code indicative of gasoline providers) and can also transmit an opening bid. The input means can also be used to accept a bid or eliminate a provider from bidding. For instance, the display 302 of PDA 400 can be used to accept a bid from a displayed provider or eliminate a displayed provider from participating in the bidding by simply touching the portion of the display 302 which displays the name of the provider or the product image transmitted by the provider.

The methods of the present invention are particularly suited to be carried out by a computer software program, such computer software program preferably containing modules corresponding to the individual steps of the methods. Such software can of course be embodied in a computer-readable medium, such as an integrated chip or a peripheral device.

Those skilled in the art will recognize the usefulness of the methods 100 of the present invention. A driver of an automobile can have gasoline providers in an area the driver is approaching bid for the driver's business. The driver of an automobile can also request providers to bid on a particular good that the driver desires, such as a hard to find toy at Christmas time. Those skilled in the art will recognize that the methods of the present invention are not limited to use in vehicles, for instance a person walking through a shopping district or mall can ask providers of food or goods to bid for the user's business. The providers can then transmit video or still images of their lunch special or particular sale items that the user is interested in and bid for the user's business. Those skilled in the art will also realize that the methods of the present invention can be utilized to assist a user in distress. For instance, a driver of an automobile can be approaching an empty level of gasoline, can have a flat tire, or have a dummy light such as an oil pressure light on. In such situations, the user can not only request a bid for services but can find a closest location to assist him or her. It can therefore be appreciated that the methods 100 of the present invention offer a significant advantage over the methods of the prior art in which such solicitations and comparisons of goods and prices must be done manually or at best while seated at a computer terminal.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A method for bidding for the products of a provider of said products, the method comprising:
contacting one or more providers of a product within a predetermined area through a first wireless transmission from a user;
initiating a bid for the product with the one or more providers through a second wireless transmission;
bidding on the product by the one or more providers; and
accepting a lowest bid on the product from one of the one or more providers through a third wireless transmission.

2. The method of claim 1, wherein the contacting step comprises transmitting the first wireless transmission with a code corresponding to the product, wherein any provider of such product that detects the first wireless transmission can participate in the bidding step.

3. The method of claim 1, wherein the initiating step comprises providing a starting bid in the second wireless transmission by the user.

4. The method of claim 3, wherein the first and second wireless transmissions comprise a single message transmission.

5. The method of claim 1, wherein the initiating step comprises providing a starting bid in the second wireless transmission by at least one of the one or more providers.

6. The method of claim 1, wherein the one or more providers comprise at least two providers and wherein the bidding step comprises:
receiving bids from each of the at least two providers to the user through a fourth wireless transmission;
transmitting the lowest of the received bids from the user to the other of the at least two providers through a fifth wireless transmission; and
repeating the receiving and transmitting steps until the lowest bid is accepted.

7. The method of claim 1, wherein the one or more providers comprise at least two providers and wherein the bidding step comprises:
transmitting bids between each of the at least two providers;
transmitting the lowest of the received bids from one of the at least two providers to the other of the at least two providers in a fourth wireless transmission;
repeating the transmitting steps until the lowest bid is accepted; and
transmitting the lowest bid to the user in a fifth wireless transmission.

8. The method of claim 7, wherein the step of transmitting bids between each of the at least two providers is through a wireless transmission.

9. The method of claim 1, wherein the accepting step comprises:
manually indicating acceptance of the lowest bid by the user; and
transmitting the indication of acceptance through the third wireless transmission to at least the provider making the lowest bid.

10. The method of claim 1, wherein the accepting step comprises:
automatically indicating acceptance of the lowest bid by the user upon fulfillment of a predetermined criteria; and
transmitting the indication of acceptance through the third wireless transmission to at least the provider making the lowest bid.

11. The method of claim 1, further comprising transmitting additional information to the user from at least one of the one or more providers to the user during the bidding step.

12. The method of claim 11, wherein the step of transmitting additional information comprises transmitting image data corresponding to the product and further comprising the step of displaying the image data to the user.

13. The method of claim 1, further comprising transmitting additional information to the user from at least one of the one or more providers after the accepting step.

14. The method of claim 13, wherein the step of transmitting additional information comprises transmitting a confirmation from the provider with the lowest bid to the user confirming that the lowest bid will be recognized by the provider making the lowest bid.

15. A program storage device readable by machine, tangibly embodying a program of instructions executable by the machine to perform method steps for bidding for the products of a provider of said products, the method comprising:
contacting one or more providers of a product within a predetermined area through a first wireless transmission from a user;
initiating a bid for the product with the one or more providers through a second wireless transmission;
bidding on the product by the one or more providers; and
accepting a lowest bid on the product from one of the one or more providers through a third wireless transmission.

16. The program storage device of claim 15, wherein the one or more providers comprise at least two providers and wherein the bidding step comprises:
receiving bids from each of the at least two providers to the user through a fourth wireless transmission;
transmitting the lowest of the received bids from the user to the other of the at least two providers through a fifth wireless transmission; and
repeating the receiving and transmitting steps until the lowest bid is accepted.

17. The program storage device of claim 15, wherein the one or more providers comprise at least two providers and wherein the bidding step comprises:
transmitting bids between each of the at least two providers;
transmitting the lowest of the received bids from one of the at least two providers to the other of the at least two providers in a fourth wireless transmission;
repeating the transmitting steps until the lowest bid is accepted; and
transmitting the lowest bid to the user in a fifth wireless transmission.

18. A computer program product embodied in a computer-readable medium for bidding for the products of a provider of said products, the computer program product comprising:
computer readable program code means for contacting one or more providers of a product within a predetermined area through a first wireless transmission from a user;
computer readable program code means for initiating a bid for the product with the one or more providers through a second wireless transmission;
computer readable program code means for bidding on the product by the one or more providers; and
computer readable program code means for accepting a lowest bid on the product from one of the one or more providers through a third wireless transmission.

19. The computer program product of claim 18, wherein the one or more providers comprise at least two providers and wherein the computer readable program code means for bidding comprises:
computer readable program code means for receiving bids from each of the at least two providers to the user through a fourth wireless transmission;
computer readable program code means for transmitting the lowest of the received bids from the user to the other of the at least two providers through a fifth wireless transmission; and
computer readable program code means for repeating the receiving and transmitting steps until the lowest bid is accepted.

20. The computer program product of claim 18, wherein the one or more providers comprise at least two providers and wherein the computer readable program code means for bidding comprises:
computer readable program code means for transmitting bids between each of the at least two providers;
computer readable program code means for transmitting the lowest of the received bids from one of the at least two providers to the other of the at least two providers in a fourth wireless transmission;
computer readable program code means for repeating the transmitting steps until the lowest bid is accepted; and
computer readable program code means for transmitting the lowest bid to the user in a fifth wireless transmission.

21. A wireless communication device comprising:
means for contacting one or more providers of a product within a predetermined area through a first wireless transmission; and
means for accepting a lowest bid on the product from one of the one or more providers through a second wireless transmission.

22. A method for receiving product information from a provider of a products, the method comprising:
contacting one or more providers of a product within a predetermined area to request product information through a first wireless transmission from a user;
receiving the product information from at least one of the one or more providers in a second wireless transmission to the user.

23. The method of claim 22, further comprising displaying the product information from the at least one provider.
